(19) United States
(12) Patent Application Publication
(10) Pub. No.: US 2011/0074573 A1
(43) Pub. Date: Mar. 31, 2011

(54) PORTABLE DEVICE WITH MULTIPLE MODALITY INTERFACES

(75) Inventor: Nambirajan Seshadri, Irvine, CA (US)

(73) Assignee: BROADCOM CORPORATION, Irvine, CA (US)

(21) Appl. No.: 12/627,850

(22) Filed: Nov. 30, 2009

Related U.S. Application Data
(60) Provisional application No. 61/246,266, filed on Sep. 28, 2009.

(51) Int. Cl. G08B 21/00; H04B 3/36; G08B 5/00; G08B 3/00; G08B 7/00; G06F 3/041; G09G 5/00; G08B 6/00; G10L 15/00; G01W 1/00; G08B 1/08

(52) U.S. Cl. 340/539.13; 340/407.1; 340/815.4; 340/384.1; 340/691.1; 340/540; 345/173; 345/168; 340/407.2; 704/246; 340/601; 340/686.1; 704/E15.001

(57) ABSTRACT

A portable device includes a plurality of interface modules and a processing module. The processing module is operably coupled to detect a user input and determine a user interface mode of operation. When the user interface mode of operation is in a first mode, the processing module enables a first one of the plurality of user interface modules to process data corresponding to the user input as the first type of human sensory data and enables a second one of the plurality of user interface modules to process the data corresponding to the user input as the second type of human sensory data.

### CROSS REFERENCE TO RELATED PATENTS

This invention is claiming priority under 35 USC §119(e) to a provisionally filed patent application having the same title as the present patent application, a filing date of Sep. 28, 2009, and an application number of 61/246,266.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention relates generally to communication systems and more particularly to portable devices that operate in such communication systems.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), WCDMA, LTE (Long Term Evolution), WiMAX (worldwide interoperability for microwave access), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to an antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers data from the filtered signals in accordance with the particular wireless communication standard.

As is also known, the transmitter includes a data modulation stage, one or more intermediate frequency stages, and a power amplifier. The data modulation stage converts data into baseband signals in accordance with a particular wireless communication standard. The one or more intermediate frequency stages mix the baseband signals with one or more local oscillations to produce RF signals. The power amplifier amplifies the RF signals prior to transmission via an antenna.

Such wireless communication devices include one or more user input and/or output interfaces to enable a user of the device to enter instructions, data, commands, speech, etc. and receive corresponding feedback. For example, many cellular telephones include a capacitive-based touch screen that allows the user to touch a particular service activation icon (e.g., make a call, receive a call, open a web browser, etc.) and the touch screen provides a corresponding visible response thereto. The capacitive-based touch screen also allows the user to scroll through selections with a finger motion.

While the capacitive-based touch screen works well from many users and/or in many situations, there are instances where such touch screens are less than effective as a user input mechanism and/or as a user output mechanism. For example, users that are visual impaired may have a difficult time reading the visual feedback. As another example, users that are physically impaired (e.g., arthritis, broken finger, etc.) may have a difficult time making the desired input selection. As a further example, when the communication device is in an area with significant ambient light (e.g., in direct sunlight), the visual feedback is difficult to read. As a still further example, when the communication device is used in a particular environment (e.g., driving a vehicle), it can be dangerous to the user to divert his/her eyes to read the communication device display.

One known solution to the above issues is to use voice activation, which utilizes speech recognition program(s) to determine convert a verbal command into a digital command for the device. Another solution is to use speech synthesis to generate audible outputs instead of visible outputs. While these solutions overcome the visual limitation of using a touch screen, they introduce new issues due to their complexity and/or inaccuracy.

Therefore, a need exists for a communication device that utilizes multiple modality interfaces.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a portable communication device in accordance with the present invention;

FIG. 2 is a logic diagram of an embodiment of a method for providing multiple modality interfaces in accordance with the present invention;

FIG. 3 is a schematic block diagram of another embodiment of a portable communication device in accordance with the present invention;

FIG. 4 is a logic diagram of another embodiment of a method for providing multiple modality interfaces in accordance with the present invention;

FIG. 5 is a schematic block diagram of another embodiment of a portable communication device in accordance with the present invention;

FIG. 6 is a schematic block diagram of another embodiment of a portable communication device in accordance with the present invention;

FIG. 7 is a logic diagram of another embodiment of a method for providing multiple modality interfaces in accordance with the present invention;

FIG. 8 is a schematic block diagram of another embodiment of a portable communication device in accordance with the present invention;

FIG. 9 is a schematic block diagram of an example of operation of a portable communication device in accordance with the present invention; and

FIG. 10 is a schematic block diagram of an example of operation of a portable communication device in accordance with the present invention.

### DETAILED DESCRIPTION OF THE INVENTION

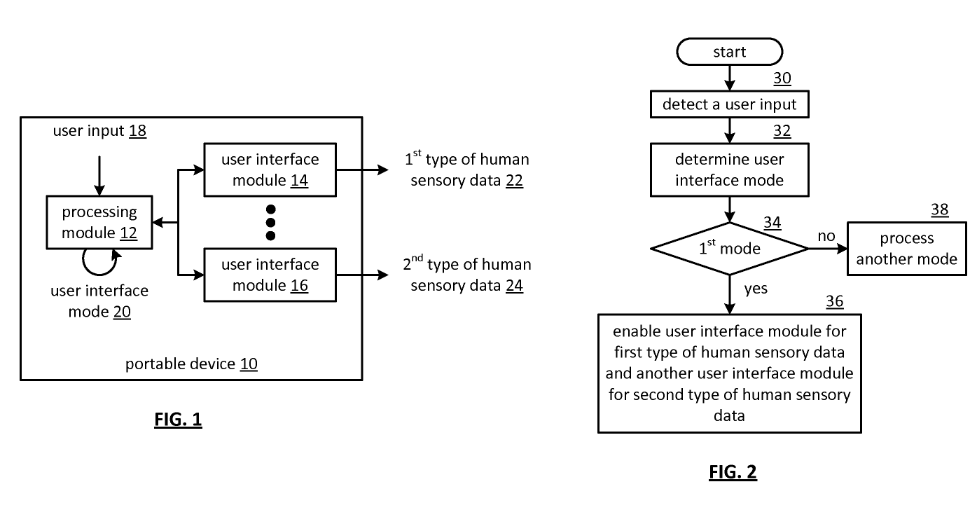

FIG. 1 is a schematic block diagram of an embodiment of a portable communication device 10 that includes a processing module 12 and a plurality of interfaces 14-16. The portable communication device 10 may be a cellular telephone, a personal digital assistant, a portable video game unit, a two-way radio, a portable video and/or audio player, a portable medical monitoring and/or treatment device, and/or any other handheld electronic device that receives inputs from a user and provides corresponding outputs of audio data, video data, tactile data, text data, graphics data, and/or a combination thereof. Note that the processing module 12 and one or more of the plurality of user interface modules 14-16 may be implemented on one or more integrated circuits.

The processing module 12 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that if the processing module includes more than one processing device, the processing devices may be centrally located (e.g., directly coupled together via a wired and/or wireless bus structure) or may be distributedly located (e.g., cloud computing via indirect coupling via a local area network and/or a wide area network). Further note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element stores, and the processing module executes, hard coded and/or operational instructions corresponding to at least some of the steps and/or functions illustrated in FIGS. 1-10.

The plurality of user interface modules 14-16 may be input interface modules and/or output interface modules. An input interface module includes hardware (e.g., one or more of wires, connectors, wireless transceivers, drivers, buffers, voltage level shifters, etc.) and software (e.g., one or more of a software driver, compression/decompression, encoding/decoding, etc.) that provides the electrical, mechanical, and/or functional connection to an input device (e.g., microphone, keypad, keyboard, touch screen, capacitive touch screen, digital camera image sensor, etc.). An output interface module includes hardware (e.g., one or more of wires, connectors, wireless transceivers, drivers, buffers, voltage level shifters, etc.) and software (e.g., one or more of a software driver, compression/decompression, encoding/decoding, etc.) that provides the electrical, mechanical, and/or functional connection to an output device (e.g., speaker(s), display, touch screen display, capacitive touch screen display, etc.).

In an example of operation, the processing module 12 receives a user input 18 via one of the plurality of user interface modules 14-16 or some other input mechanism. The user input 18 is signal that corresponds to a particular operational request (e.g., select a particular operational function, initiate a particular operational function, terminate a particular operational function, suspend a particular operation function, modify a particular operation function, etc.). For instance, the user input 18 may correspond to the user positioning his or her finger over an icon on a touch screen display regarding a particular operational request. As a specific example, the user's finger is positioned over an icon regarding a web browser application, a cellular telephone call, a contact list, a calendar, email, a user application, a video game application, etc.

Once the processing module 18 detects the user input 18, it determines a user interface mode of operation 20. This may be done in a variety of ways. For example, the mode may be preprogrammed into the device 10, may be user selected, may be determined based on user parameters, use parameters, and/or environmental conditions, etc. The mode of operation 20 may indicate which user interface modules 14-16 are active, which user interface modules are collectively active, which user interface modules are inactive, etc. When the user interface mode of operation is in a first mode, the processing module enables a first user interface module to process data corresponding to the user input as the first type of human sensory data 22 and enables a second user interface module to process the data corresponding to the user input as the second type of human sensory data 24.

As a specific example, assume that a portable device is a cellular telephone with a touch screen. In this example, the user's finger is positioned over an icon corresponding to a web browser application. One the user interface modules processes the input signal (e.g., identifying of the web browser application) as video graphics data (e.g., a first type of human sensory data) and a second user interface module processes the input signal as audible data (e.g., generates an audible signal that indicates that the user's finger is positioned on the web browser application). As such, the user is getting two types of feedback for the same input signal: audio and visual in this example.

The example continues with the user's finger being repositioned to another icon on the touch screen if the user does not want to active the web browser application. In this instance, the user interface modules would be produce visual and audible information regarding the new icon. If, however, the user desires to open the web browser application, the user provides another input signal 18 (e.g., provides one or two touches on the icon and/or a verbal command) to open the application. The user interface modules provide audible and visual information regarding the opening of the web browser application.

The example continues with the user navigating through the web browser application with the user interface modules providing audible and visual information regarding the navigation. As a specific example, the user's finger may be positioned over a favorite web site icon. The user interface modules provide audible and visual information regarding the favorite web site. For instance, the audible information may indicate the name of the web site (e.g., shoes and socks.com) and may further provide audible information regarding a next action (e.g., “would you like to open shoes and socks.com”).

As a further example, the touch screen may include tactile feedback (e.g., vibration units, electronic stimulus, etc.) to provide a tactile feedback. Thus, a user may receive visual, audible, and tactile information regarding a particular operation request. For instance, the tactile feedback may indicate when the user's finger is positioned over an icon, where the audible and visual information indicates the data corresponding to the icon. The tactile feedback may further indicate a type of application associated with the icon.

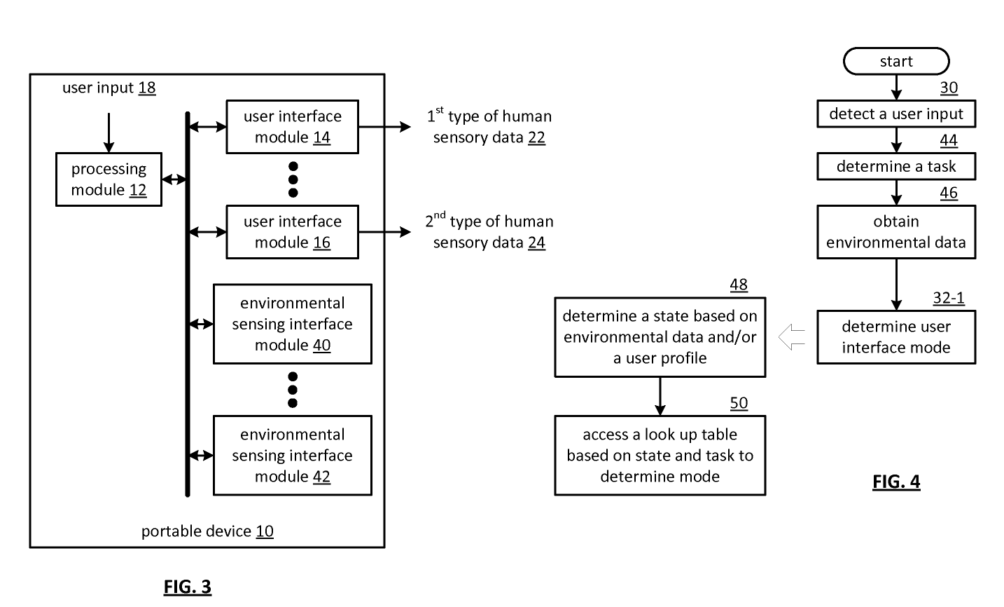

FIG. 2 is a logic diagram of an embodiment of a method for providing multiple modality interfaces that begins at step 30 where the processing module 18 detects a user input 18. The method continues at step 32 where the processing module 18 determines a user interface mode of operation 20. This may be done in a variety of ways. For example, the processing module may interpret a mode of operation setting (e.g., a preprogrammed setting, a user inputted setting, etc.) As another example or in furtherance of the preceding example, the processing module may determine an environmental state (e.g., indoors, outdoors, moving, stationary, in a vehicle, etc.) of the portable device and, based on the environmental state, access a state look up table to determine the mode of operation. As yet another example or in furtherance of one or more of the preceding examples, the processing module may determine a task type of the user input (e.g., initiate a cell phone call, answer a cell phone call, retrieve a file, play a music file, play a video file, a verbal command, a keypad entry, a touch screen entry, et.) and, based on the task type, accessing a task type look up table to determine the mode of operation. As a further example or in furtherance of one or more of the preceding examples, the processing module determines a state of a user (e.g., hearing impaired, visually impaired, physically impaired, etc.) and, based on the state of the user, accessing a user state look up table.

The method branches at step 34 to step 36 when the user interface mode of operation is in a first mode and to step 38 when it is not. At step 38, the processing module processes the user input in accordance with another mode of operation (e.g., use one user interface module: visual or audible information). At step 36, the processing module enables a first user interface module to process data corresponding to the user input as the first type of human sensory data (e.g., visual) and enables a second user interface module to process the data corresponding to the user input as the second type of human sensory data (e.g., audible).

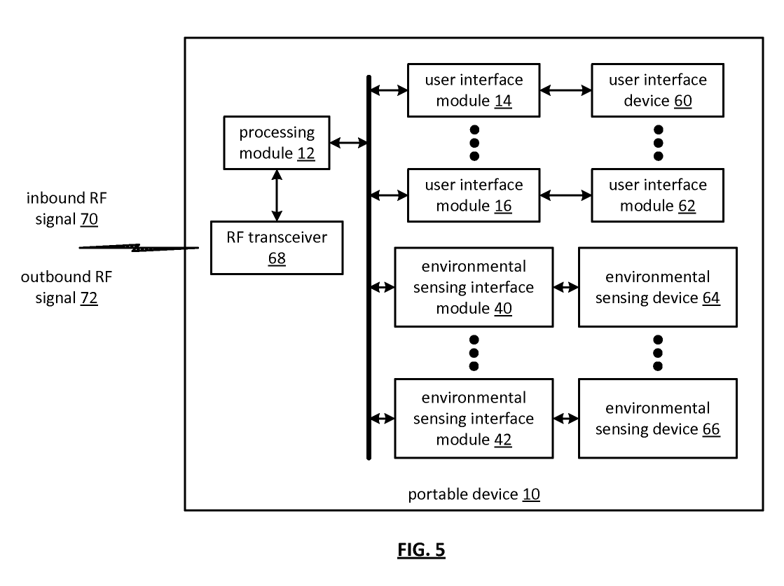

FIG. 3 is a schematic block diagram of another embodiment of a portable communication device 10 that includes the processing module 12, the plurality of user interface modules 14-16, and a plurality of environmental sensing interface modules 40-42. Each of the environmental sensing interface modules includes hardware (e.g., one or more of wires, connectors, wireless transceivers, drivers, buffers, voltage level shifters, etc.) and software (e.g., one or more of a software driver, compression/decompression, encoding/decoding, etc.) that provides the electrical, mechanical, and/or functional connection to an environmental sensing device (e.g., gyroscope, compass, weather sensor (temperature, barometric pressure, humidity), distance detector (e.g., a laser tape measure), a global positioning satellite (GPS) receiver, etc.).

In an example of operation, the processing module 12 receives the user input 18 and receives environmental data (e.g., weather information, motion information, geographic positioning information, environmental surroundings information, etc.) from one or more of the environmental sensing interface modules 40-42. The processing module 18 determines a task based on the user input 18 and determines the user interface mode of operation based on the task and the environmental data.

FIG. 4 is a logic diagram of another embodiment of a method for providing multiple modality interfaces that begins at step 30 where the processing module 18 detects a user input 18. The method continues at step 44 where the processing module 18 determines a task based on the user input. The method continues at step 46 where the processing module obtains environmental data, which may be received from one or more of the environmental sensing interface modules 40-42, retrieved from memory, received via one or more of the user interface modules 14-16 (e.g., downloaded from the internet via a web browser application), etc.

The method continues at step 32-1 where the processing module determines the user interface mode based on the task and/or the environmental data. For instance, as shown with reference to steps 48 and 50, the processing module 18 may determine a state of the portable device based on at least one of the environmental data and a user profile (e.g., user preferences, user identification information, etc.). The state may be one or more of indoors and stationary, indoors and moving, outdoors and stationary, outdoors and moving, outdoors and low ambient light, outdoors and high ambient light, in a vehicle, hearing impaired, sight impaired, and physically impaired.

At step 50, the processing module 18 accesses a look up table based on the state and the task to determine the user interface mode of operation. The user mode of operation may be one or more of the first type (e.g., normal visual data and normal audible data, with optional normal tactile data), a second type for hands free operation (e.g., voice recognition only, Bluetooth enabled, etc.), a third type for a noisy area (e.g., normal visual data and amplified audible data, with optional normal tactile data), a fourth type for a quiet area (e.g., normal visual data and whisper mode audible data, with optional normal tactile data), a fifth type for high ambient light (e.g., amplified visual data and normal audible data, with optional normal tactile data), a sixth type for low ambient light (e.g., dimmed visual data and normal audible data, with optional normal tactile data), a seventh type for in vehicle use (e.g., combination of first type and third type), an eighth type for stationary use (e.g., combination of first and fourth types), a ninth type for mobile use (e.g., similar to hands free), and a tenth type based on a user profile (e.g., hearing impaired (e.g., visual data with amplified audible data and tactile data), visually impaired (e.g., use first type), physically impaired (e.g., priority to audible user interfaces, adjust size of icon to reduce dexterity requirements, etc.)).

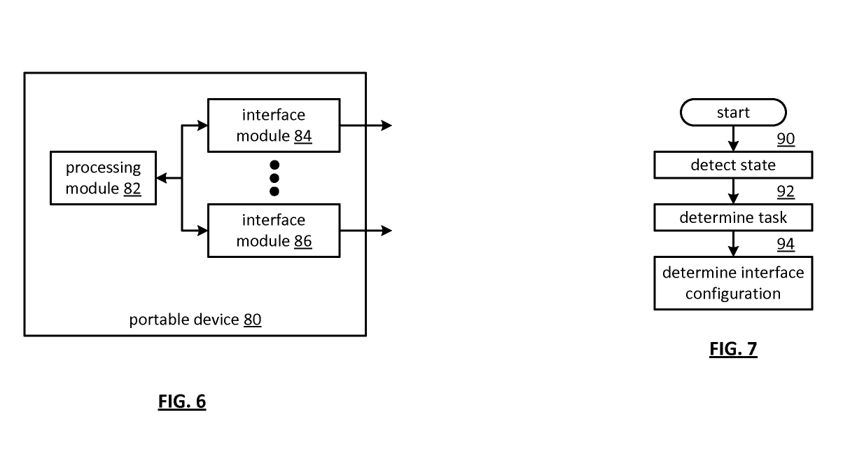

FIG. 5 is a schematic block diagram of another embodiment of a portable communication device 10 that includes the processing module 12, the plurality of user interface modules 14-16, the plurality of environmental sensing interface modules 40-42, a radio frequency (RF) transceiver 68, a plurality of user interface devices 60-62, and a plurality of environmental sensing devices 64-66. In this embodiment, the RF transceiver 68 may support cellular telephone calls, cellular data communications, wireless local area network communications, wireless personal area networks, etc.

The RF transceiver 68 includes a receiver section and a transmitter section. The receiver section converts an inbound RF signal 70 into an inbound symbol stream. For instance, the receiver section amplifies the inbound RF signal 70 to produce an amplified inbound RF signal. The receiver section may then mix in-phase (I) and quadrature (Q) components of the amplified inbound RF signal with in-phase and quadrature components of a local oscillation to produce a mixed I signal and a mixed Q signal. The mixed I and Q signals are combined to produce the inbound symbol stream. In an embodiment, the inbound symbol may include phase information (e.g., +/−Δθ [phase shift] and/or θ(t) [phase modulation]) and/or frequency information (e.g., +/−Δf [frequency shift] and/or f(t) [frequency modulation]). In another embodiment and/or in furtherance of the preceding embodiment, the inbound RF signal includes amplitude information (e.g., +/−ΔA [amplitude shift] and/or A(t) [amplitude modulation]). To recover the amplitude information, the receiver section includes an amplitude detector such as an envelope detector, a low pass filter, etc.

The processing module 12 converts the inbound symbol stream into inbound data (e.g., voice, text, audio, video, graphics, etc.) in accordance with one or more wireless communication standards (e.g., GSM, CDMA, WCDMA, HSUPA, HSDPA, WiMAX, EDGE, GPRS, IEEE 802.11, Bluetooth, ZigBee, universal mobile telecommunications system (UMTS), long term evolution (LTE), IEEE 802.16, evolution data optimized (EV-DO), etc.). Such a conversion may include one or more of: digital intermediate frequency to baseband conversion, time to frequency domain conversion, space-time-block decoding, space-frequency-block decoding, demodulation, frequency spread decoding, frequency hopping decoding, beamforming decoding, constellation demapping, deinterleaving, decoding, depuncturing, and/or descrambling. The processing module 12 then provides the inbound data to the first and second ones of the plurality of user interface modules for presentation as the first type of human sensory data and the second type of human sensory data.

For outbound signaling, the processing module 12 converts outbound data into the outbound symbol stream in accordance with the user input. For instance, the processing module 12 converts outbound data (e.g., voice, text, audio, video, graphics, etc.) as identified based on the user input into outbound symbol stream in accordance with one or more wireless communication standards (e.g., GSM, CDMA, WCDMA, HSUPA, HSDPA, WiMAX, EDGE, GPRS, IEEE 802.11, Bluetooth, ZigBee, universal mobile telecommunications system (UMTS), long term evolution (LTE), IEEE 802.16, evolution data optimized (EV-DO), etc.). Such a conversion includes one or more of: scrambling, puncturing, encoding, interleaving, constellation mapping, modulation, frequency spreading, frequency hopping, beamforming, space-time-block encoding, space-frequency-block encoding, frequency to time domain conversion, and/or digital baseband to intermediate frequency conversion.

The transmitter section of the RF transceiver 68 converts the outbound symbol stream into an outbound RF signal 72. For instance, the transmitter section converts the outbound symbol stream into an outbound RF signal that has a carrier frequency within a given frequency band (e.g., 57-66 GHz, etc.). In an embodiment, this may be done by mixing the outbound symbol stream with a local oscillation to produce an up-converted signal. One or more power amplifiers and/or power amplifier drivers amplifies the up-converted signal, which may be RF bandpass filtered, to produce the outbound RF signal. In another embodiment, the transmitter section includes an oscillator that produces an oscillation. The outbound symbol stream provides phase information (e.g., +/−Δθ [phase shift] and/or θ(t) [phase modulation]) that adjusts the phase of the oscillation to produce a phase adjusted RF signal, which is transmitted as the outbound RF signal. In another embodiment, the outbound symbol stream includes amplitude information (e.g., A(t) [amplitude modulation]), which is used to adjust the amplitude of the phase adjusted RF signal to produce the outbound RF signal.

In yet another embodiment, the transmitter section includes an oscillator that produces an oscillation. The outbound symbol provides frequency information (e.g., +/−Δf [frequency shift] and/or f(t) [frequency modulation]) that adjusts the frequency of the oscillation to produce a frequency adjusted RF signal, which is transmitted as the outbound RF signal. In another embodiment, the outbound symbol stream includes amplitude information, which is used to adjust the amplitude of the frequency adjusted RF signal to produce the outbound RF signal. In a further embodiment, the transmitter section includes an oscillator that produces an oscillation. The outbound symbol provides amplitude information (e.g., +/−ΔA [amplitude shift] and/or A(t) [amplitude modulation) that adjusts the amplitude of the oscillation to produce the outbound RF signal.

In the embodiment of FIG. 5, the combination of user interface modules 14-16 and user interface devices 60-62 may include two or more of: a display and a display driver; a visual touch screen and a visual touch screen driver; a key pad and a key pad driver; a tactile touch screen and a tactile touch screen driver; one or more speakers and corresponding audio processing circuitry; one or more microphones and a speech coding module; the one or more microphones and a voice recognition module; and an image sensor and digital image processing circuitry. The plurality of environmental sensing devices 64-66 and the plurality of environmental sensing interface modules 40-42 include two or more of: a compass and a compass driver; a weather condition sensor and a weather conditions driver; a gyroscope and a gyroscope driver; a distance detector and a distance detector driver; and a global positioning satellite (GPS) receiver.

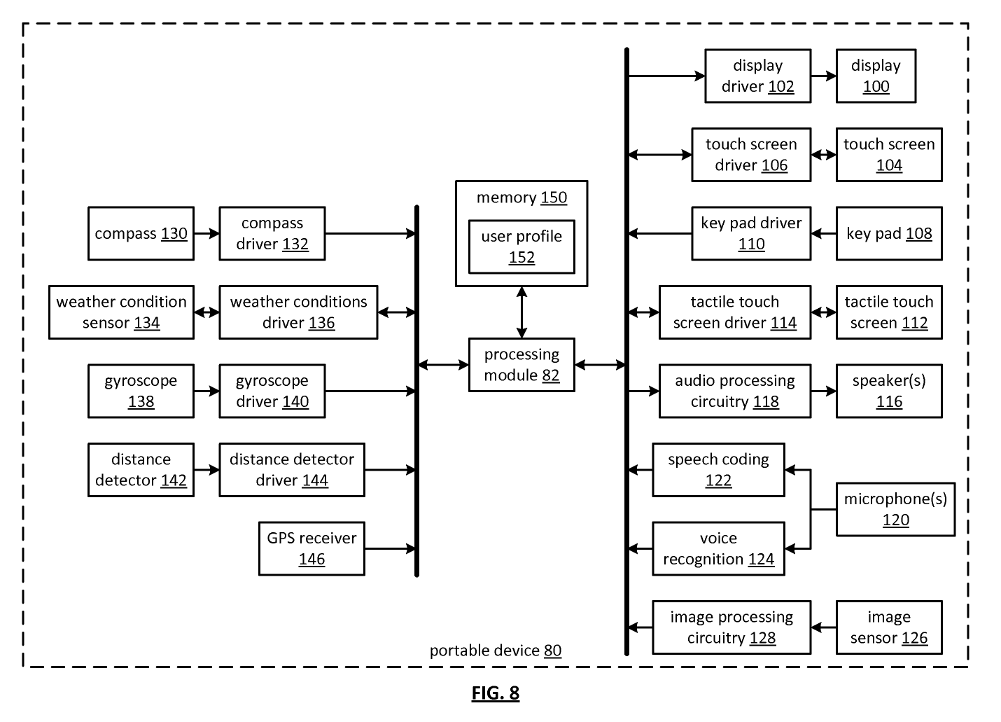

FIG. 6 is a schematic block diagram of another embodiment of a portable communication device 80 that includes a processing module 82 and a plurality of interface modules 84-86. The portable communication device 80 may be a cellular telephone, a personal digital assistant, a portable video game unit, a two-way radio, a portable video and/or audio player, a portable medical monitoring and/or treatment device, and/or any other handheld electronic device that receives inputs from a user and provides corresponding outputs of audio data, video data, tactile data, text data, graphics data, and/or a combination thereof. Note that the processing module 82 and one or more of the plurality of interface modules 84-86 may be implemented on one or more integrated circuits.

The processing module 82 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that if the processing module includes more than one processing device, the processing devices may be centrally located (e.g., directly coupled together via a wired and/or wireless bus structure) or may be distributedly located (e.g., cloud computing via indirect coupling via a local area network and/or a wide area network). Further note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element stores, and the processing module executes, hard coded and/or operational instructions corresponding to at least some of the steps and/or functions illustrated in FIGS. 6-10.

The plurality of interface modules 84-86 may include a plurality of user interface modules (e.g., 14-16) and/or a plurality of environmental sensing interface modules (e.g., 40-42). The plurality of interface modules 84-86 may be coupled to one or more of a plurality of user interface devices and/or to one or more of a plurality of environmental sensing devices. FIG. 5 provides examples of the devices and corresponding interface modules.

FIG. 7 is a logic diagram of another embodiment of a method for providing multiple modality interfaces that begins at step 90 where the processing module 82 detects the state of the portable device based on input from at least one of the plurality of interface modules. For example, the input may be based on data corresponding to the current task (e.g., access a web browser, access an email account, make a cellular telephone call, send a text message, etc.) as generated by a user interface module and/or environmental data as generated by an environmental sensing interface module. Note that the state may be one or more of: indoors and stationary; indoors and moving; outdoors and stationary; outdoors and moving; outdoors and low ambient light; outdoors and high ambient light; in a vehicle; hearing impaired; sight impaired; and physically impaired.

The method continues at step 92 where the processing module 82 determines a current task of the portable device (e.g., open a web browser application, close a web browser application, go to a site, etc.). The method continues at step 94 where the processing module 82 determines an interface configuration of at least some of the plurality of interface modules based on the state and the current task. For example, the processing module may determine the state based on the environmental data and/or user data and may determine the interface configuration by accessing a look up table based on the state and the current task.

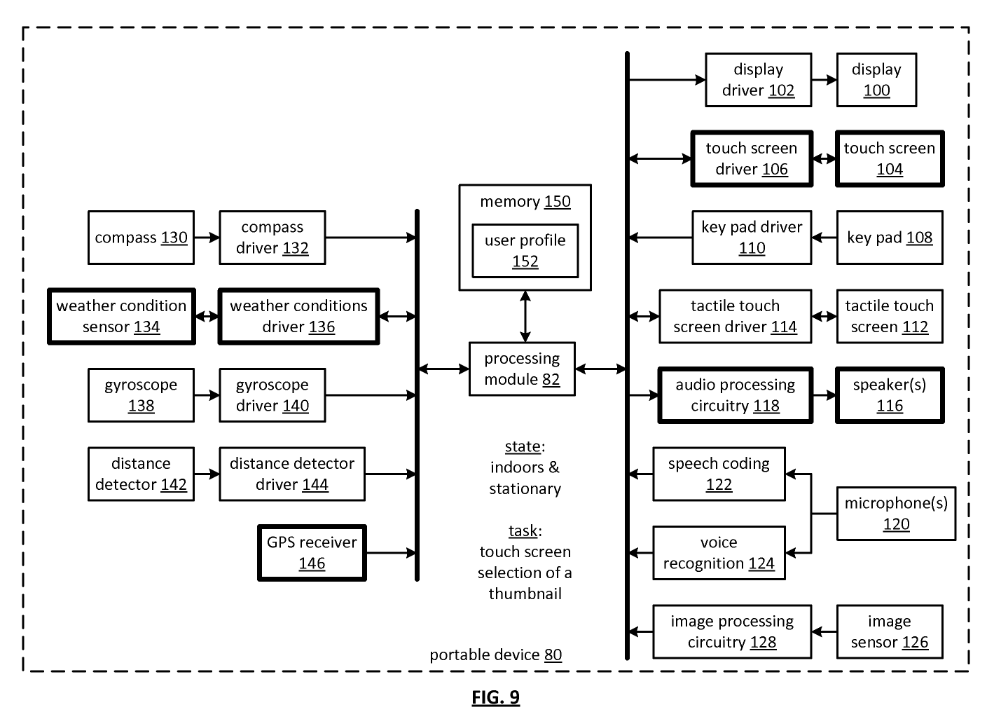

FIG. 8 is a schematic block diagram of another embodiment of a portable communication device 80 that includes the processing module 82, a plurality of interface modules, a plurality of devices, and memory 150. The plurality of interface modules includes two or more of a display driver 102, a touch screen driver 106, a keypad driver 110, a tactile touch screen driver 114, audio processing circuitry 118, a speech coding module 122, a voice recognition module 124, image processing circuitry 128, a compass driver 132, a weather conditions driver 136, a gyroscope driver 140, a distance detection driver 144, and an interface for a GPS receiver 146. The plurality of devices includes two or more of a display 100, a touch screen 104, a keypad 108, a tactile touch screen 112, one or more speakers 116, one or more microphones 120, an image sensor 126, a compass 130, a weather condition sensor, a gyroscope 138, and a distance detector 142. Note that the memory 150 may store a user profile 152.

In this embodiment, there is a wide range of data that the processing module 82 may use to determine the interface configuration mode. For example, various weather conditions may be used to determine whether the device 80 is indoors or out, the level of ambient light, etc. The speech coding and/or voice recognition modules may be used to determine background noise, the type of noise, and/or its level. The GPS receiver 146 may be used to determine the device's position (e.g., at a public place, at a private place, etc.). The image sensor may be used to help determine the environmental conditions of the device 80.

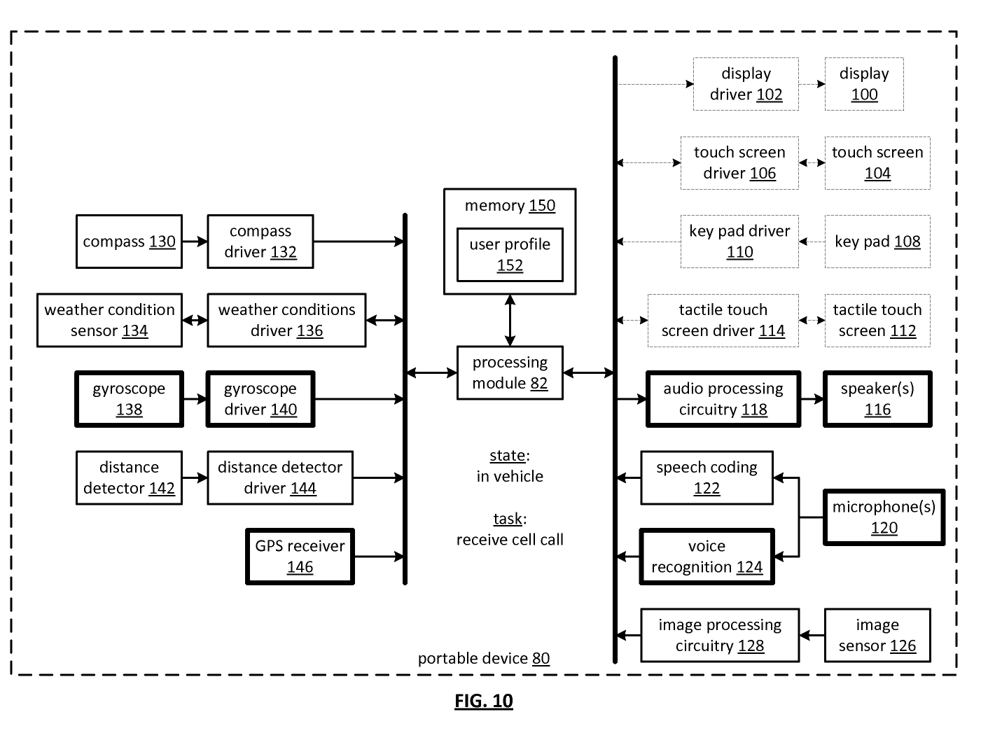

FIG. 9 is a schematic block diagram of the portable communication device 80 in a specific environmental condition and a corresponding interface mode. In this specific example, the weather condition sensor 134, its driver 136, and the GPS receiver 146 are active to provide environmental data to the processing module 82. The processing module 82 utilizes the environmental data to determine that the state of the device 80 is indoors and relatively stationary. Further information may be provided such that the processing module determines that both visual data and audible data should be created for one or more particular operational requests. As such, the touch screen 104, its driver 106, the speaker(s) 116, and the audio processing circuitry 118 are active to provide the multiple modality user interfaces of visual and audible data. Thus, for each touch of an icon, both visual and audible data will be created and presented.

FIG. 10 is a schematic block diagram of the portable communication device 80 in a specific environmental condition and a corresponding interface mode. In this specific example, the gyroscope 138, its driver 140, and the GPS receiver are active to determine that the device is in a moving vehicle. In this state, the processing module 82 configures the interfaces for hands-free operation, such that the speaker(s) 116, the audio processing circuitry 118, the microphone(s) 120, and the voice recognition module are active. The other devices and their interface modules are inactive.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A portable device comprises:
a plurality of user interface modules, wherein a first one of the plurality of user interface modules processes a first type of human sensory data and a second one of the plurality of user interface modules processes a second type of human sensory data; and
a processing module operably coupled to:
detect a user input;
determine a user interface mode of operation; and
when the user interface mode of operation is in a first mode, enable the first one of the plurality of user interface modules to process data corresponding to the user input as the first type of human sensory data and enable the second one of the plurality of user interface modules to process the data corresponding to the user input as the second type of human sensory data.

2. The portable device of claim 1, wherein the processing module determines the user interface mode of operation by at least one of:
interpreting a mode of operation setting;
determining an environmental state of the portable device and, based on the environmental state, access a state look up table;
determining task type of the user input and, based on the task type, accessing a task type look up table; and
determining state of a user and, based on the state of the user, accessing a user state look up table.

3. The portable device of claim 1 further comprises:
a plurality of environmental sensing interface modules, wherein an environmental sensing interface module of the plurality of environmental sensing interface modules generates environmental data from a sensed environmental condition; and
wherein the processing module is further operably coupled to:
determine a task based on the user input; and
determine the user interface mode of operation based on the task and the environmental data.

4. The portable device of claim 3, wherein the processing module is further operably coupled to:
determine a state of the portable device based on at least one of the environmental data and a user profile; and
access a look up table based on the state and the task to determine the user interface mode of operation.

5. The portable device of claim 4, wherein state comprises at least one of:
indoors and stationary;
indoors and moving;
outdoors and stationary;
outdoors and moving;
outdoors and low ambient light;
outdoors and high ambient light;
in a vehicle;
hearing impaired;
sight impaired; and
physically impaired.

6. The portable device of claim 3, wherein the user mode of operation comprises at least one of:
the first type;
a second type for hands free operation;
a third type for a noisy area;
a fourth type for a quiet area;
a fifth type for high ambient light;
a sixth type for low ambient light;
a seventh type for in vehicle use;
an eighth type for stationary use;
a ninth type for mobile use; and
a tenth type based on a user profile.

7. The portable device of claim 3 further comprises:
a plurality of user interface devices operably coupled to the plurality of user interface modules; and
a plurality of environmental sensing devices operably coupled to the plurality of environmental sensing interface modules, wherein the plurality of user interface devices and the plurality of user interface modules include, respectively, two or more of:
a display and a display driver;
a visual touch screen and a visual touch screen driver;
a key pad and a key pad driver;
a tactile touch screen and a tactile touch screen driver;
one or more speakers and corresponding audio processing circuitry;
one or more microphones and a speech coding module;
the one or more microphones and a voice recognition module;
an image sensor and digital image processing circuitry; and
wherein the plurality of environmental sensing devices and the plurality of environmental sensing interface modules include, respectively, two or more of:
a compass and a compass driver;
a weather condition sensor and a weather conditions driver;
a gyroscope and a gyroscope driver;
a distance detector and a distance detector driver; and
a global positioning satellite (GPS) receiver.

8. The portable device of claim 1 further comprises:
a radio frequency (RF) transceiver operably coupled to:
convert an inbound RF signal into an inbound symbol stream; and
convert an outbound symbol stream into an outbound RF signal; and
wherein the processing module is further operably coupled to:
convert outbound data into the outbound symbol stream in accordance with the user input;
convert the inbound symbol stream into inbound data; and
provide the inbound data to the first and second ones of the plurality of user interface modules for presentation as the first type of human sensory data and the second type of human sensory data.

9. The portable device of claim 1, wherein each of the first and second types of human sensory data comprises at least one of:
audible data;
visual data; and
tactile data.

10. The portable device of claim 1 further comprises:
an integrated circuit that supports the processing module and at least some of the plurality of user interface modules.

11. A portable device comprises:
a plurality of interface modules; and
a processing module operably coupled to:
detect state of the portable device based on input from at least one of the plurality of interface modules;
determine a current task of the portable device; and
determine an interface configuration of at least some of the plurality of interface modules based on the state and the current task.

12. The portable device of claim 11, wherein the plurality of interface modules comprises:
a plurality of user interface modules, wherein a user interface module of the plurality of interface modules generates data corresponding to the current task; and
a plurality of environmental sensing interface modules, wherein an environmental sensing interface module of the plurality of environmental sensing interface modules generates environmental data from a sensed environmental condition, wherein the input includes information from at least one of the plurality of user interface modules and one of the plurality of environmental sensing interface modules.

13. The portable device of claim 12, wherein the processing module is further operably coupled to:
determine the state based on at least one of the environmental data and user data; and
access a look up table based on the state and the current task to determine the interface configuration.

14. The portable device of claim 13, wherein state comprises at least one of:
indoors and stationary;
indoors and moving;
outdoors and stationary;
outdoors and moving;
outdoors and low ambient light;
outdoors and high ambient light;
in a vehicle;
hearing impaired;
sight impaired; and
physically impaired.

15. The portable device of claim 12 further comprises:
a plurality of user interface devices operably coupled to the plurality of user interface modules; and
a plurality of environmental sensing devices operably coupled to the plurality of environmental sensing interface modules, wherein the plurality of user interface devices and the plurality of user interface modules include, respectively, two or more of:
a display and a display driver;
a visual touch screen and a visual touch screen driver;
a key pad and a key pad driver;
a tactile touch screen and a tactile touch screen driver;
one or more speakers and corresponding audio processing circuitry;
one or more microphones and a speech coding module;
the one or more microphones and a voice recognition module;
an image sensor and digital image processing circuitry; and
wherein the plurality of environmental sensing devices and the plurality of environmental sensing interface modules include, respectively, two or more of:
a compass and a compass driver;
a weather condition sensor and a weather conditions driver;
a gyroscope and a gyroscope driver;
a distance detector and a distance detector driver; and
a global positioning satellite (GPS) receiver.

16. The portable device of claim 11 further comprises:
a radio frequency (RF) transceiver operably coupled to:
convert an inbound RF signal into an inbound symbol stream; and
convert an outbound symbol stream into an outbound RF signal; and
wherein the processing module is further operably coupled to:
convert outbound data into the outbound symbol stream in accordance with the current task;
convert the inbound symbol stream into inbound data; and
provide the inbound data to first and second ones of the plurality of user interface modules for presentation as a first type of human sensory data and a second type of human sensory data.

17. The portable device of claim 16, wherein each of the first and second types of human sensory data comprises at least one of:
audible data;
visual data; and
tactile data.

18. The portable device of claim 11 further comprises:
an integrated circuit that supports the processing module and at least some of the plurality of interface modules.
